(19) United States
(12) Patent Application Publication
(10) Pub. No.: US 2009/0240360 A1
(43) Pub. Date: Sep. 24, 2009

(54) MEDIA PLAYER AND AUDIO PROCESSING METHOD THEREOF

(75) Inventors: LUNG DAI, Tu-Cheng (TW); WANG-CHANG DUAN, Shenzhen City (CN); BANG-SHENG ZUO, Shenzhen City (CN)

Correspondence Address: PCE INDUSTRY, INC.;ATT. Steven Reiss, 458 E. LAMBERT ROAD, FULLERTON, CA, 92835, US

(73) Assignees: HON FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/348,324

(22) Filed: Jan. 5, 2009

(30) Foreign Application Priority Data
Mar. 18, 2008 (CN) 200810300617.X

(51) Int. Cl. G06F 17/00

(52) U.S. Cl. 700/94

(57) ABSTRACT

A media player includes an input unit for receiving an audio select input for selecting audio files to be played by the media player, audio decode units for decoding the audio files into corresponding audio signals respectively, and audio output channels for simultaneously outputting the audio signals respectively.

### BACKGROUND

1. Field of the Invention

Embodiments of the present disclosure relate to media players, and particularly to a media player and its audio processing method.

2. Description of Related Art

Almost all motion pictures (such as films), television programs, and video games are initially designed with an original language audio track. Dubbing tracks are later added for different languages. On conventional media players, only one of the tracks (original dialogue or dubbing) can be selected when the film or the video game is played. When two persons are viewing a film on the same media player, one person may have a preference for one language and the other person may have a preference for another language, but because the media player will only allow one audio track to be played this presents an inconvenience to the two persons viewing the film.

Therefore, an improved media player and its audio processing method are needed to address the aforementioned deficiency and inadequacies.

Other advantages and novel features of the present disclosure will become more apparent from the following detailed description of preferred embodiment when taken in conjunction with the accompanying drawings.

### BRIEF DESCRIPTION OF THE DRAWINGS

FIG. 1 is a block diagram showing a media player in accordance with an embodiment of the present disclosure.

FIG. 2 is a flow chart of an audio processing method in accordance with an embodiment of the present disclosure.

### DETAILED DESCRIPTION OF CERTAIN INVENTIVE EMBODIMENTS

References will now be made to the drawings to describe certain inventive embodiments of the present disclosure.

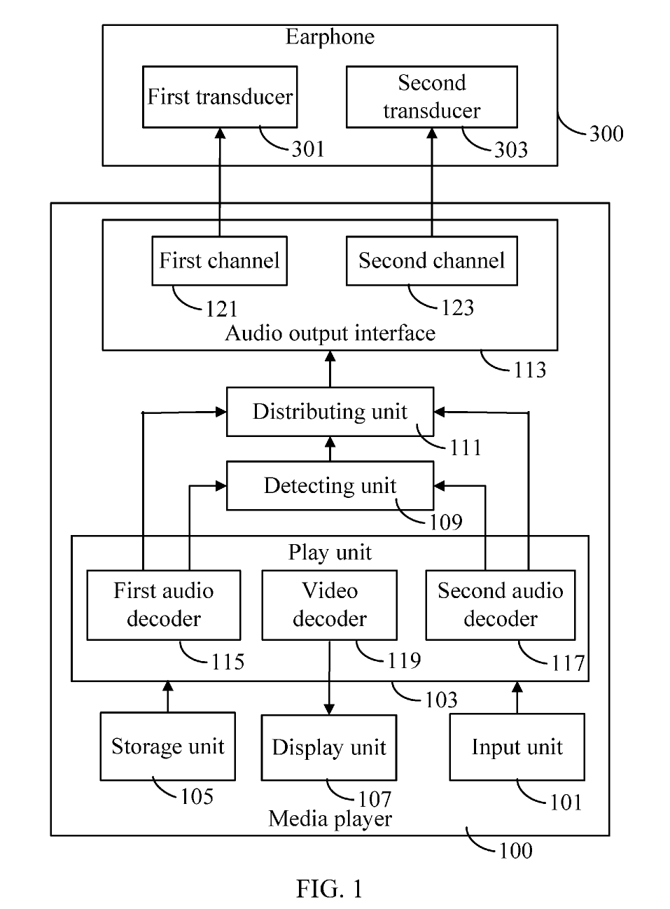

Referring to FIG. 1, a media system including a media player 100 and an earphone 300 in accordance with an exemplary embodiment is illustrated. The earphone 300 has a pair of transducers: a first transducer 301 and a second transducer 303. The first transducer 301 and the second transducer 303 are disposed in separate earpieces (not shown). One user can wear one earpiece, and another user can wear the other earpiece. The media player 100 is capable of outputting different audio signals to respective transducers 301, 303 simultaneously. It should be noted that the transducer can be any electro-acoustic transducer for converting electric signals into sounds.

The media player 100 may include an input unit 101, a play unit 103, a storage unit 105, a display unit 107, a detecting unit 109, a distributing unit 111, and an audio output interface 113.

The storage unit 105 is used for storing audio and video files. There may be a one-to-one or one-to-more relationship between the video files and the audio files. In other words, each of the video files is associated with one or more corresponding audio files. In other embodiments, the storage unit 105 may be replaced by an external storage device or media, such as a compact disc, a storage card, or a portable hardware.

The input unit 101 is for receiving user's inputs. The inputs may include a video select input for selecting a video file to be played, an audio select input for selecting one or more audio files to be played. The one or more audio files may correspond to the video file desired to be played.

The play unit 103 is used for reading the selected video files from the storage unit 105 according to the video select input, reading the selected one or more audio files according to the audio select input, and playing the selected video and audio files. The one or more audio files may be one or more songs, or one or more dubbing tracks of a film. The play unit 103 may include a first audio decoder 115, a second audio decoder 117, and a video decoder 119.

The video decoder 119 is configured for decoding the video file read from the storage unit 105 to generate a video signal, and sending the video signal to the display unit 107 which then displays images corresponding to the video signal. The first and second audio decoders 115, 117 are configured for decoding the one or more audio files read from the storage unit 105 into one or more audio signals, and sending the one or more audio signals to the distributing unit 111. Each of the first and second audio decoders 115, 117 can decode only one audio file at a time. In this embodiment, when two audio files are selected, the first and second audio decoders 115, 117 simultaneously decode the two audio files respectively to generate a first audio signal and a second audio signal. When only one audio file is selected via the input unit 101, the first audio decoder 115 is chosen to decode the audio file into the first audio signal. In other embodiments, when the two audio files are selected, the first and second audio decoders 115, 117 decode the two audio files respectively, but maybe not at the same time.

The detecting unit 109 is configured for generating a distributing signal when determining that the first and second audio decoders 115, 117 operate simultaneously, that is, two audio files are selected and decoded. The detecting unit 109 generates a non-distributing signal when determining that only the first audio decoder 115 operates, that is, only one audio file is selected and decoded. In other embodiments, the detecting unit 109 may generate the distributing signal when the input unit 101 receives the audio select input for selecting two audio files to be played, and generate the non-distributing signal when the input unit 101 receives the audio select input for selecting only one audio file.

The audio output interface 113 is configured for outputting the first and/or the second audio signals. The audio output interface 113 includes a first channel 121 capable of being connected to the first transducer 301 of the earphone 300, and a second channel 123 capable of being connected to the second transducer 303.

The distributing unit 111 is configured for transmitting the first audio signal and the second audio signal to the first and second channels 121, 123 respectively according to the distributing signal. As a result, the first and second channels 121, 123 output different audio signals. If the earphone 300 is connected to the audio output interface 113, different sounds corresponding to the two audio files will be output by the first and second transducers 301, 303. The distributing unit 111 is further configured for transmitting the first audio signal to both the first and second channels 121, 123 according to the non-distributing signal. As a result, sound corresponding to the first audio signal will be output by the first and second transducers 301, 303 when the earphone 300 is connected to the audio output interface 113.

As described above, when a film having a video file and two audio files (an original track and a dubbing track, for example) is selected to be played on the media player 100. The media player 100 may receive the video select input for selecting the video file first, and then receive the audio select input for selecting the two audio files. In response, the media player 100 decodes the video file into a video signal and displays images corresponding to the video signal on the display unit 107, decodes the two audio files into the first and second audio signals using the first and second audio decoders 115, 117 respectively, and simultaneously sends the first and second audio signals to the first and second transducers 301, 303 respectively via the first and second channels 121, 123. As a result, two users can listen to the two audio files respectively via the first and second transducers 301, 303.

In other embodiments, the display unit 107 may be replaced by an external display device.

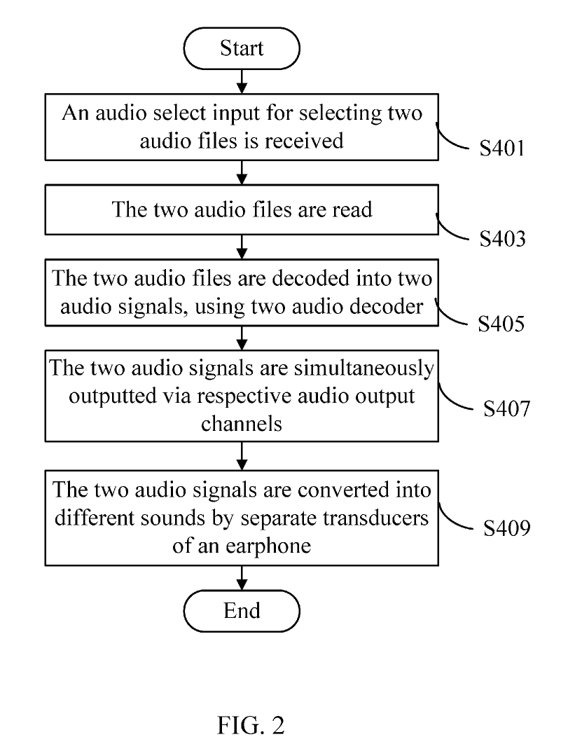

Referring to FIG. 2, a flow chart of an audio processing method for a media player is illustrated. The media player may be the media player 100. The audio processing method may include the following steps. The various actions in the audio processing method may be performed in the order presented, or may be performed in a different order. Furthermore, in some embodiments, some actions listed in FIG. 2 may be omitted from the audio processing method.

In step S401, an audio select input for selecting two audio files is received.

In step S403, the two audio files are read from an inner or external storage media.

In step S405, the two audio files are decoded into two audio signals, respectively, using two audio decoders. The two audio files may be decoded simultaneously or not.

In step S407, the two audio signals are simultaneously output via respective audio output channels.

In step S409, the two audio signals are converted into different sounds by respective transducers. The transducers are disposed in separate earpieces of an earphone. One user can wear one earpiece, and another user can wear the other earpiece.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A media player, comprising:
an input unit for receiving an audio select input for selecting two audio files to be played by the media player;
two audio decode units for simultaneously decoding the selected two audio files into a first audio signal and a second audio signal correspondingly; and
two audio output channels for simultaneously outputting the first audio signal and the second audio signal respectively.

2. The media player as claimed in claim 1, further comprising:
a detecting unit for generating a distributing signal when determining that the two audio decode units operate simultaneously; and
a distributing unit for transmitting the first audio signal and the second audio signal to the two audio output channels respectively according to the distributing signal.

3. The media player as claimed in claim 1, further comprising a video decode unit for decoding a selected video file, the input unit is further used for receiving a video select input for selecting the selected video file.

4. The media player as claimed in claim 3, further comprising a display unit for displaying images corresponding to the decoded video file.

5. The media player as claimed in claim 1, further comprising an earphone comprising a first transducer capable of connecting to one of the two audio output channels, and a second transducer capable of connecting to the other of the two audio output channels.

6. A media player, comprising:
an input unit for receiving an audio select input for selecting a plurality of audio files to be played by the media player;
a plurality of audio decode units for decoding the plurality of audio files into corresponding audio signals respectively; and
a plurality of audio output channels for simultaneously outputting the plurality of audio signals respectively.

7. The media player as claimed in claim 6, further comprising:
a detecting unit for generating a distributing signal when the input unit receives the audio select input for selecting a plurality of audio files; and
a distributing unit for transmitting the plurality of audio signals to the plurality of audio output channels respectively according to the distributing signal.

8. The media player as claimed in claim 6, further comprising a video decode unit for decoding a selected video file, the input unit is further used for receiving a video select input for selecting the selected video file.

9. The media player as claimed in claim 8, further comprising a display unit for displaying the decoded video file.

10. An audio processing method for a media player, the method comprising:
reading two audio files;
decoding the two audio files to generate a first audio signal and a second audio signal; and
simultaneously outputting the first audio signal and the second audio signal via respective audio output channels.

11. The audio processing method as claimed in claim 10, further comprising receiving an audio select input for selecting the two audio files before reading the two audio files.
